(19) United States
(12) Patent Application Publication
(10) Pub. No.: US 2020/0198061 A1
(43) Pub. Date: Jun. 25, 2020

(54) METHOD OF MANUFACTURING FINE WIRE

(71) Applicant: Pusan National University Industry-University Cooperation Foundation, Busan (KR)

(72) Inventors: Younghoon MOON, Busan (KR); Taewoo HWANG, Busan (KR); Sangwook HAN, Busan (KR); Youngyun WOO, Busan (KR); Ilyeong OH, Busan (KR)

(73) Assignee: Pusan National University Industry-University Cooperation Foundation, Busan (KR)

(21) Appl. No.: 16/245,494

(22) Filed: Jan. 11, 2019

(30) Foreign Application Priority Data
Dec. 21, 2018 (KR) 10-2018-0167791

(51) Int. Cl. B23K 26/354; B22F 3/00; B22F 5/12; B23K 26/34; B21C 1/02

(52) U.S. Cl. CPC B23K 26/354; B22F 3/004; B23K 2101/32; B23K 26/34; B21C 1/02; B22F 5/12

(57) ABSTRACT

Disclosed is a method of manufacturing a fine wire suitable for speedy and small quantity production of a fine wire having a desired cross-sectional area at low cost without being restricted much by a material. The method includes: stacking a metal powder on an upper surface of a molding plate in which a plurality of semicircular molding grooves are formed in parallel; melting the metal powder by projecting a laser beam onto the metal powder stacked on the upper surface of the molding plate, wherein the laser beam is projected along the molding grooves to melt the metal powder; and removing the remaining metal powder when the melted metal powder is solidified so that a wire is formed in the molding grooves of the molding plate.

### CROSS-REFERENCE TO RELATED APPLICATION

This application claims priority to and the benefit of Korean Patent Application No. 10-2018-0167791 filed on Dec. 21, 2018, the disclosure of which is incorporated herein by reference in its entirety.

### BACKGROUND

The present invention relates to a method of manufacturing a fine wire, and more particularly, to a method of manufacturing a fine wire suitable for speedy and small quantity production of a fine wire having a desired cross-sectional area at low cost without being greatly restricted by a material.

Generally, a metal wire is manufactured using a cold drawing technology.

The wire drawing technology for manufacturing metal wires is one cold molding process technology, in which a cross-sectional area of a wire is gradually reduced by a conical die. The surface quality and hardness of the wire are improved as the cross-sectional area of the wire is reduced through a drawing process.

However, such a conventional wire drawing technology is limited in a material to be used, wherein the material is suitable for mass production but has a problem of not being suitable for small quantity production. In addition, there is a problem in that a great deal of waste is generated during a manufacturing process. Accordingly, it has not been suitable for producing high-quality wires using various materials for special purposes such as recent medical devices or experimental instruments.

### PRIOR ART DOCUMENT

### Patent Document

Korean Laid-Open Patent Publication No. 10-1996-0033581 (Oct. 22, 1996)

### SUMMARY

The present invention is directed to providing a method of manufacturing a fine wire which is suitable for speedy and small quantity production of a fine wire having a desired cross-sectional area at low cost without being restricted much by a material.

According to an aspect of the present invention, there is provided a method of manufacturing a wire using a metal powder which includes stacking a metal powder on an upper surface of a molding plate in which a plurality of semicircular molding grooves are formed in parallel, melting the metal powder by projecting a laser beam onto the metal powder stacked on the upper surface of the molding plate, wherein the laser beam is projected along the molding grooves to melt the metal powder, and removing the remaining metal powder when the melted metal powder is solidified so that a wire is formed in the molding grooves of the molding plate.

Here, the molding plate may be a copper molding plate formed of a copper material.

A thickness of the stacked metal powder may be greater than a width of the molding groove by 0.1 mm.

Various molding plates having molding grooves with different sizes may be provided, and the molding plate corresponding to a thickness of the wire may be selected and used.

The method may further include rotating the wire primarily formed of the metal powder in a circumferential direction of the wire in the molding grooves of the molding plate and projecting a laser beam onto the rotated wire again to melt the wire so as to secondarily form the wire.

The projecting of the laser beam onto the primarily formed wire may be performed with output greater than that of the projecting of the laser beam onto the metal powder.

A rotating angle of the wire may be 180°.

The method may further include performing a drawing process on the wire formed of the metal powder using a die so as to improve a surface roughness and a roundness of the wire.

The method may further include rotating the wire primarily formed of the metal powder in a circumferential direction in the molding grooves of the molding plate, projecting a laser beam onto the rotated wire again to melt the wire to secondarily form the wire, and performing a drawing process on the secondarily formed wire using a die, which may be sequentially performed to gradually improve a surface roughness, a roundness, and a hardness of the wire.

According to another aspect of the present invention, there is provided a molding apparatus for manufacturing a wire using a metal powder, including a molding plate in which a plurality of semicircular molding grooves are formed in parallel in an upper surface of a flat plate type body of the molding plate, wherein a metal powder is stacked on the upper surface, and a laser beam is projected onto the metal powder along the molding grooves to melt the metal powder so as to form a wire, and including a laser beam projector configured to project a laser beam onto the metal powder stacked on the molding plate.

Here, the molding plate may further include a base having an upper surface which supports the molding plate, a powder feeder configured to supply the metal powder to be stacked on the molding plate, and a layering bar configured to apply the metal powder on the upper surface of the molding plate while moving along the upper surface of the base.

An installation part of the base, which supports the molding plate, may be recessed downward from the upper surface of the base and the molding plate may not protrude from the upper surface of the base when the layering bar moves to stack the metal powder on the molding plate.

The molding apparatus may further include a lift cylinder installed under the base to lift the installation part.

The molding apparatus may further include a chamber box configured to accommodate the molding plate on the upper surface of the base, wherein an upper surface of the chamber box may be formed of a transparent material through which the laser beam transmits, a lower surface of the chamber box may be open to accommodate the molding plate by simply placing the chamber box on the upper surface of the base in a state in which the molding plate is mounted on the upper surface of the base and include a gas supplier configured to supply an inert gas to the chamber box.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart for describing a method of manufacturing a fine wire according to an embodiment of the present invention;

FIG. 2 is a reference view for describing the method of manufacturing a fine wire according to the embodiment of the present invention;

FIGS. 3 and 4 are perspective views illustrating molding plates used in the method of manufacturing a fine wire according to the present embodiment of the present invention;

FIG. 5 is a configuration diagram for describing an apparatus for manufacturing a fine wire according to the embodiment of the present invention;

FIG. 6 is an image of a molding plate actually made for use in the method of manufacturing a fine wire and the apparatus for manufacturing the same according to the embodiment of the present invention;

FIGS. 7 to 9 are images of a wire sequentially formed by a melting process in which an output of a primary laser beam projection is 25 W, a remelting process in which an output of a secondary laser beam is 50 W, and a drawing process in which a die having a width of 0.4 mm is used;

FIGS. 10 to 12 are images of a wire sequentially formed by a melting process in which an output of a primary first laser beam projection is 200 W, a remelting process in which an output of a secondary laser beam is 200 W, and the drawing process in which a die having a width of 0.8 mm is used;

FIG. 13 is a roundness analysis image of the wire formed by the melting process in which the output of the primary laser beam projection is 25 W, and the remelting process in which the output of the secondary laser beam is 50 W;

FIG. 14 is a roundness analysis image of the wire formed by the melting process in which the output of the primary laser beam projection is 200 W, and the remelting process in which the output of the secondary laser beam is 200 W;

FIG. 15 is a comparison graph showing vertical/horizontal ratios of wires formed by the primary laser projection, the secondary laser projection, and the drawing processes;

FIG. 16 is a compression graph showing average surface roughnesses of the wires formed by the primary laser projection, the secondary laser projection, and the drawing processes; and

FIG. 17 is a graph showing a distribution of hardness values before and after a process of drawing a wire is performed.

### DETAILED DESCRIPTION

A method of manufacturing a fine wire according to embodiments of the present invention will be described with reference to the accompanying drawings. As the invention allows for various changes and numerous embodiments, specific embodiments will be illustrated in the drawings and described in detail in the written description. However, this is not intended to limit the present invention to specific modes of practice, and it is to be appreciated that all changes, equivalents, and substitutes that do not depart from the spirit and technical scope of the present invention are encompassed in the present invention. Like numbers refer to like elements throughout the description of the figures. In the accompanying drawings, sizes of structures may be greater than those of actual structures to clarify clearness of the present invention or may be smaller than those of the actual structure such that a schematic structure of the present invention is understood.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present invention. Meanwhile, unless otherwise defined, all terms (including technical and scientific terms) used herein are to be interpreted as is customary in the art to which this invention belongs. It should be further understood that terms in common usage should also be interpreted as is customary in the relevant art and not in an idealized or overly formal sense unless expressly so defined herein.

### Embodiment

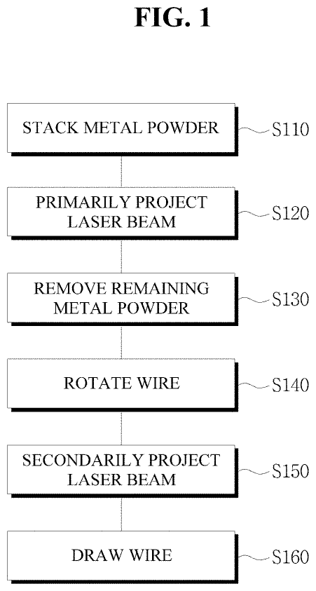

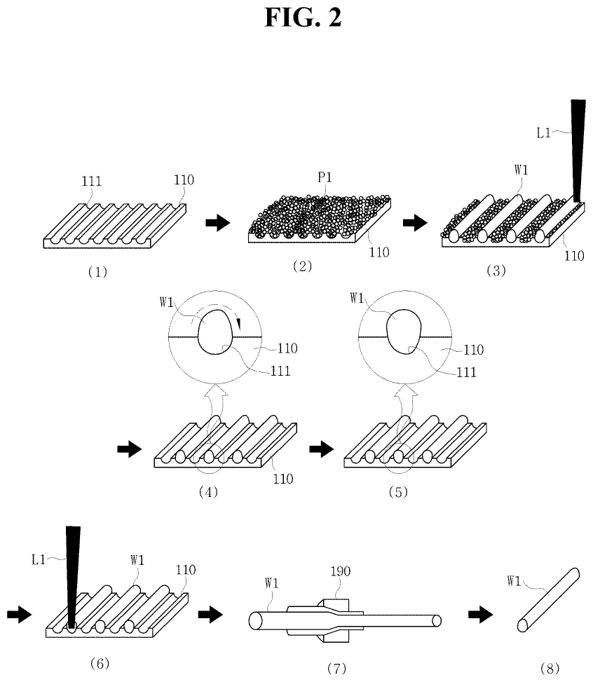

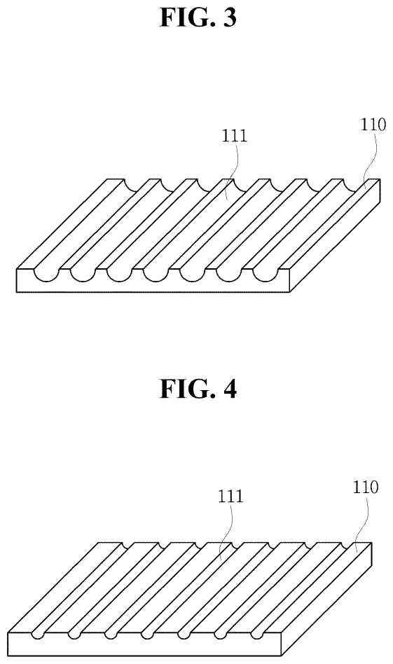

FIG. 1 is a flowchart for describing a method of manufacturing a fine wire according to an embodiment of the present invention, FIG. 2 is a reference view for describing the method of manufacturing a fine wire according to the embodiment of the present invention, and FIGS. 3 and 4 are perspective views illustrating molding plates used in the method of manufacturing a fine wire according to the present embodiment of the present invention.

The method of manufacturing a fine wire according to the present invention is based on a fact that a bead is generated during welding, and a wire is manufactured of the bead generated when a laser beam is projected in a state in which a metal powder of a desired material is applied. To this end, as illustrated in FIGS. 3 and 4, sequential processes are individually performed using a newly invented molding plate.

Hereinafter, a method of manufacturing a fine wire according to the present invention will be described in more detail.

As illustrated in FIG. 1, the method of manufacturing a fine wire according to the present invention includes stacking a metal powder on a molding plate (S110), primarily projecting a laser beam onto the metal powder (S120), removing the remaining metal powder (S130), rotating a wire (S140), secondarily projecting a laser beam onto the wire (S150), and drawing the wire (S160).

First, the stacking of the metal powder (S110) is performed. In this process, the metal powder is stacked on an upper surface of a molding plate 110 to have a predetermined thickness as illustrated in FIG. 2(2). In the molding plate 110 used in this process, a plurality of semicircular molding grooves 111 are formed in parallel on the upper surface thereof and should be made of a material having a sufficiently high thermal conductivity such that the melted metal powder P1 is not scorched and adhered thereto as illustrated in FIGS. 3 and 4. In addition, it can be seen by comparing FIGS. 3 and 4 that various molding plates 110 having the molding grooves 111 having different sizes are provided in advance and selectively used in accordance with a thickness of a wire W1 to be formed. Copper having a high thermal conductivity and low cost is suitable as the material of the molding plate 110. However, the material of the molding plate 110 is not limited to only copper.

Then, the primary projecting of the laser beam (S120) is performed. In this process, as illustrated in FIG. 2(3), a laser beam L1 is projected onto the metal powder stacked on the upper surface of the molding plate 110 to melt the metal powder. In this case, the projecting of the laser beam L1 is performed along the molding groove 111 of the molding plate 110, and the molding groove 111 is filled with the melted liquid of the metal powder P1 to gradually form the wire W1. Then, when the melted liquid of the metal powder P1 is solidified, the primarily molded wire W1 is formed in a state in which the primarily molded wire W1 is inserted into the molding groove 111 of the molding plate 110.

Then, the removing of the remaining metal powder S130 is performed. In this process, the remaining metal powder which remains after the wire W1 is formed of the metal powder is removed from the molding plate 110.

Then, the rotating of the wire (S140) is performed. In this process, the wire W1 primarily formed in the molding groove 111 of the molding plate 110 is rotated by 180° in a circumferential direction of the wire W1 as illustrated in FIGS. 2(4) and 2(5). Upper and lower sides of the wire W1 are reversed. The rotating of the wire W1 may be performed by a separate apparatus, but it is preferable that an operator manually perform the rotating from a cost viewpoint.

Then, the secondary projecting of the laser beam S150 is performed. In this process, the laser beam L1 is secondarily projected into the wire W1 to melt the wire W1 rotated by 180° as illustrated in FIG. 2(6) so that the wire W1 is secondarily formed. A surface roughness, a roundness, and a hardness of the wire W1 which is secondarily formed by projecting the laser beam L1 into the wire W1 which is primarily formed are improved from those of the wire W1 which is primarily formed by projecting the laser beam L1 into the metal powder P1. This will be described in detail below based on experimental results.

Then, the drawing of the wire (S160) is performed. In this process, as shown in (7) of FIG. 2, the drawing process is performed on the secondarily formed wire W1 using a drawing die. As a result, the surface roughness, the roundness, and the hardness of the wire W1 on which the drawing process is performed are improved as compared with those of the secondarily formed wire W1. Then, manufacturing of the wire W1 is completed.

As described above, in the method of manufacturing a fine wire according to the embodiment of the present invention, the wire W1 is manufactured by simply projecting the laser beam L1 into the metal powder P1, the molding plate 110 in which the molding groove 111 is formed is actively used, the wire W1 formed by the primary projecting of the laser beam L1 is rotated to perform the secondary projecting of the laser beam L1 onto the wire W1, and then the drawing process is performed on the wire W1, thereby gradually improving the surface roughness, the roundness, and the hardness of the wire W1 so that the high quality wire W1 can be manufactured.

Next, an apparatus for manufacturing a fine wire designed to be suitable for performing the method of manufacturing a fine wire described above will be described below.

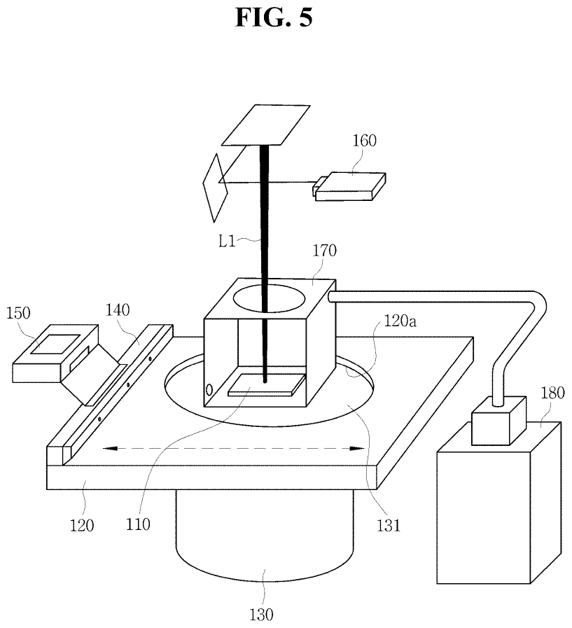

FIG. 5 is a configuration diagram for describing the apparatus for manufacturing a fine wire according to the embodiment of the present invention.

The apparatus for manufacturing a fine wire according to the embodiment of the present invention includes a molding plate 110, a base 120, a lift cylinder 130, a layering bar 140, a powder feeder 150, a projector 160 of a laser beam L1, a chamber box 170, and a gas supplier 180. Hereinafter, the apparatus for manufacturing a fine wire according to the embodiment of the present invention will be described with reference to the above components.

As described above, a plurality of semicircular molding grooves 111 are formed in parallel on an upper surface of the molding plate 110. The molding plate 110 should be made of a material having a sufficiently high thermal conductivity such that a melted metal powder P1 is not scorched and adhered to the molding plate 110. In addition, as compared through FIGS. 3 and 4, various molding plates 110 having the molding grooves 111 having different sizes are provided such that the molding plate 110 is selectively used according to a thickness of a wire W1 to be formed. Copper having a high thermal conductivity and low cost is suitable for the material of the molding plate 110, but the material of the molding plate 110 is not necessarily limited to copper.

The upper surface of the base 120 serves to support the molding plate 110. In the base 120, an installation part 131 which supports the molding plate 110 is formed in a shape of a disk and installed to be recessed downward from the upper surface of the base 120. Thus, the base 120 includes a circular open portion 120a so that the installation part 131 is formed. The installation part 131 is installed to be supported by the lift cylinder 130 and be capable of moving up and down.

The lift cylinder 130 serves to support the disc-shaped installation part 131 of the base 120 from a lower side thereof and raise the installation part 131 as necessary.

The layering bar 140 serves to apply and stack the metal powder P1 on the upper surface of the molding plate 110 while reciprocating along the upper surface of the base 120. Since the molding plate 110 is in a state of being mounted on the installation part 131 recessed from the upper surface of the base 120, the molding plate 110 and the upper surface of the base 120 do not interfere with each other when the layering bar 140 applies the metal powder P1 on the molding plate 110.

The powder feeder 150 serves to supply the metal powder P1 to the layering bar 140. Preferably, the powder feeder 150 is coupled to the layering bar 140 to be moved together.

The projector 160 of the laser beam L1 is installed at a position spaced upward from the base 120 in a state in which the projector 160 is supported by a moving unit (not shown) to be capable of precisely moving along the molding groove 111 of the molding plate 110 mounted on the installation part 131 of the base 120. The projector 160 of the laser beam L1 capable of controlling a laser output is provided so as to change an intensity of the laser beam L1 according to a thickness of the wire W1 to be formed and a processing process.

The chamber box 170 serves to accommodate the molding plate 110 disposed on the upper surface of the base 120 in a state in which the chamber box 170 is sealed. To this end, an upper surface of the chamber box 170 is formed with a transparent lens through which the laser beam L1 transmits, and a lower surface thereof is open. When the lower surface of the chamber box 170 is open as described above, the chamber box 170 may accommodate the molding plate 110 therein even though the chamber box 170 is simply placed on the base 120 in a state in which the molding plate 110 is placed on the installation part 131 of the base 120.

The gas supplier 180 is connected to the chamber box 170 through a hose to supply an inert gas to the chamber box 170. The inert gas supplied by the gas supplier is preferably an argon gas, and the inert gas is used to prevent oxidation.

Next, an experiment in which a high quality wire W1 was actually produced by applying the apparatus for manufacturing a fine wire and the method of manufacturing a fine wire according to the above-described embodiment of the present invention will be described below.

### EXPERIMENTAL EXAMPLE

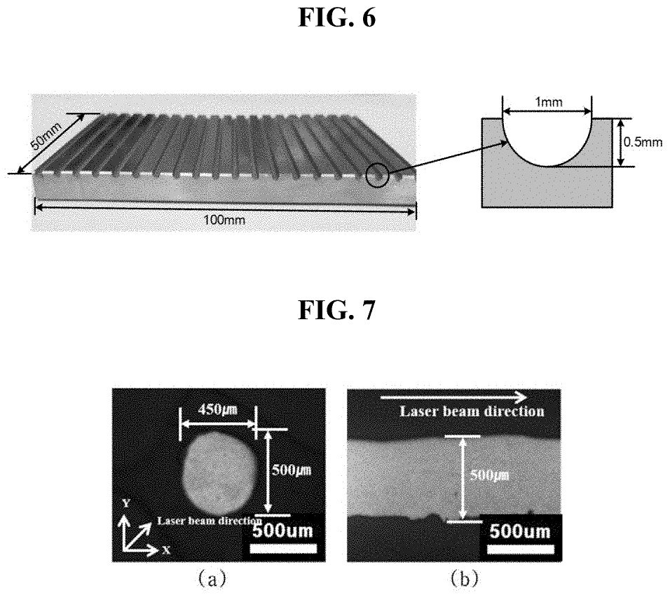

In this experiment, a spherical SUS304 powder having an average size of 25 μm was used as a metal powder. As illustrated in FIG. 6, a copper molding plate made of copper material was used. For projecting a laser beam, a direct laser melting apparatus having capabilities in which a maximum output power was 200 W, a diameter of a laser beam was 0.08 mm, and a projection speed was in the range of 3.66 to 732 mm/s was used. During the experiment, an argon gas, which was an inert gas, was supplied to prevent an oxidation phenomenon.

—Metal Powder Applying

A metal powder was applied on a copper molding plate, and a thickness of the applied metal powder was greater than a diameter of the molding groove of the molding plate by 0.1 mm as shown in Table 1 below.

TABLE 1

| | | | | |
|---|---|---|---|---|
| Diameter of Groove of Copper Plate (mm) | 1 | 0.8 | 0.6 | 0.4 |
| Depth of Powder Layering (mm) | 1.1 | 0.9 | 0.7 | 0.5 |

—Primary Laser Beam Projection

A molding plate in which a width and a depth of a molding groove were respectively 0.4 mm and 0.2 mm was mounted on the molding apparatus, and a laser beam was primarily projected along the molding groove of the molding plate. In this case, a laser output was 25 W, a projection speed was 3.66 mm/s, and a supply flow rate of the argon gas was 8 L/min. A longitudinal cross-sectional area and a side cross-sectional area of a primarily formed wire after completion of the primary laser projection can be shown in FIGS. 7A and 7B. A shape of the primarily formed wire was generally rough and uneven.

—Secondary Laser Beam Projection

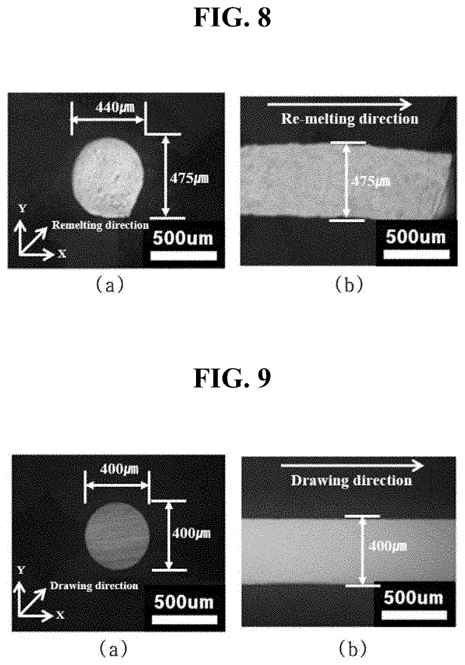

The primarily formed wire was manually rotated by 180° in the molding groove of the molding plate by an operator. Then, the laser beam was secondarily projected along the molding groove of the molding plate. In this case, the laser output was 50 W, which was greater than that of the previous laser output, the projection speed was 3.66 mm/s, and the supply flow rate of the argon gas was 8 L/min. A longitudinal cross-sectional area and a side cross-sectional area of the secondarily formed wire after completion of the secondary laser projection can be shown in FIGS. 8A and 8B. It can be seen that a shape of the secondarily formed wire was improved from viewpoints of surface roughness and roundness compared to the primarily formed wire.

FIG. 13 is a graph showing the roundness of the cross-section of the wire using TDI Plus, which is an image analysis program. FIG. 13A shows that the roundness of the cross-section of the wire was 95% when the laser beam was primarily projected with the laser power of 25 W, and FIG. 13B shows that the roundness of the cross-section of the wire was 97% when the wire was secondarily projected by the laser beam having a laser power of 50 W and remelted.

—Drawing Process

The drawing process was performed on the secondarily formed wire using a die in which a width thereof was 0.4 mm. A longitudinal cross-sectional area and a side cross-sectional area of the wire on which the drawing process was performed can be shown in FIGS. 9A and 9B, and it can be seen that the surface roughness and the roundness are further improved compared to those of the secondarily formed wire.

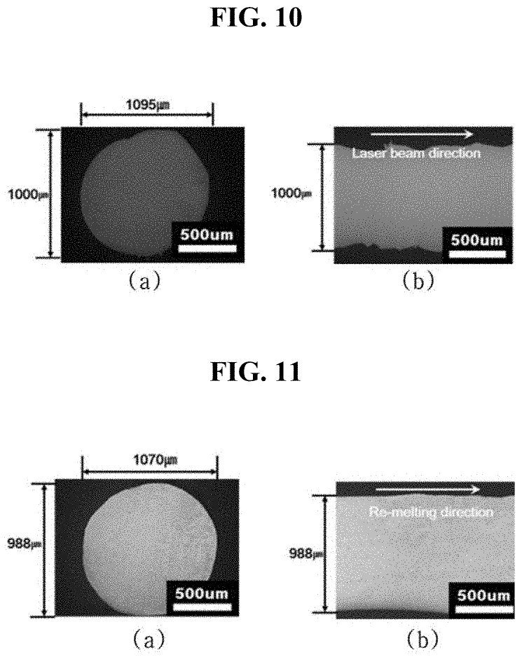

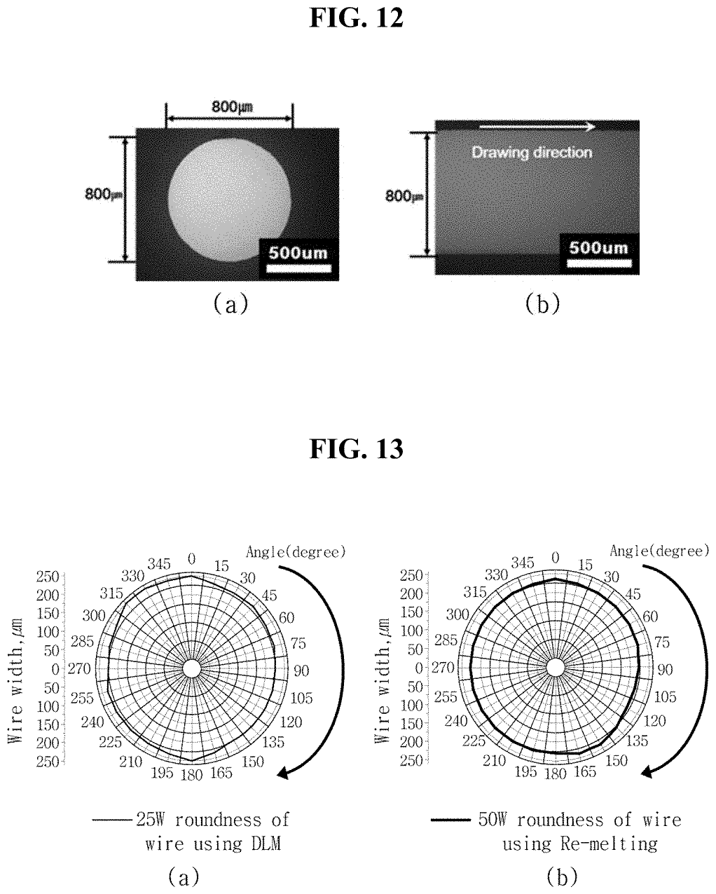

Meanwhile, the molding plate was changed to a molding plate in which a width and a depth of a molding groove were respectively 1 mm and 0.5 mm, and the changed molding plate was mounted on the molding apparatus. Both laser outputs were changed to 200 W, and the laser beam was primarily and secondarily projected. When the drawing process was performed using a die in which a width was 0.8 mm, a shape of a wire was gradually improved as shown in FIGS. 10, 11, and 12. As shown in FIGS. 10, 11, and 12, as an amount of input heat of the laser increases during the primary laser projection, a surface of the wire tends to be relatively rough, but when the secondary laser projection and the drawing process were performed on the wire, a surface roughness thereof was improved, and the wire was transformed into a high quality wire in which a roundness thereof is 100%.

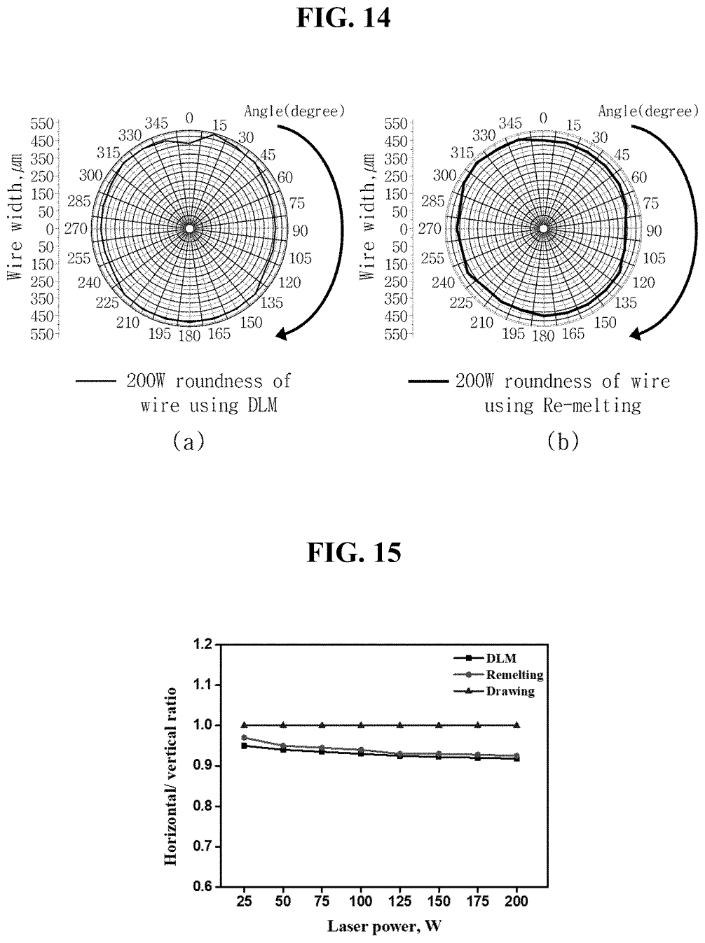

FIG. 14 is a graph showing a roundness of a cross-section of the wire using TDI Plus, which is the image analysis program. FIG. 14A shows that the roundness of the cross-section of the wire was 93.08% when the laser beam was primarily projected with the laser power of 200 W, and FIG. 14B shows the roundness of the cross-section of the wire is 95.36% when the wire was secondarily projected by the laser beam having the laser power of 50 W and remelted.

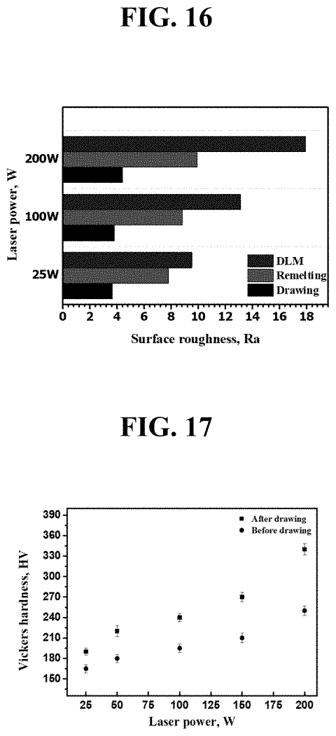

Meanwhile, FIGS. 15 and 16 show characteristics of the three processes (the primary laser projection, the secondary laser projection, and the drawing process) which form the wire. As shown in FIG. 15, a vertical/horizontal ratio of the wire is closer to one when the laser was projected for remelting compared to when the laser was initially projected. This indicates that a size and a shape of the wire can be directly controlled by adjusting process variables in the laser melting process and the remelting process.

FIG. 16 shows a difference in a surface roughness according to a process condition. When the laser projection speed was fixed at 3.66 mm/s and an amount of input heat was increased, the surface roughness of the wire was increased. It can be seen that when the remelting process was performed as a method to solve the increase in the surface roughness, there was an effect in that the surface roughness is remarkably reduced, and when the drawing process was performed, the surface roughness was further improved.

FIG. 17 shows a distribution of hardness values. When a laser projection speed was fixed at 3.66 mm/s and the laser output was increased, it can be seen that a hardness was increased, and a hardness value of the wire was considerably increased after the drawing process was performed. It is determined that the reason why the hardness value of the wire is considerably increased while the wire passes through the mold having various sizes during the drawing process is because work hardening occurs in the process.

As described above, the present invention is advantageous in that a small quantity production of a fine wire having a desired cross-sectional area can be performed at low cost without being restricted by a material.

As described above, although the exemplary embodiments of the present invention have been described, various changes, modifications, and equivalents may be used according to the present invention. It is clear that the embodiments may be properly modified and applied to the present invention. Therefore, the above descriptions do not limit a scope of the present invention defined by a limitation of the scope of the following claims of the present invention.

1. A method of manufacturing a wire using a metal powder, comprising:
stacking a metal powder on an upper surface of a molding plate in which a plurality of semicircular molding grooves are formed in parallel;
melting the metal powder by projecting a laser beam onto the metal powder stacked on the upper surface of the molding plate, wherein the laser beam is projected along the molding grooves to melt the metal powder; and
removing the remaining metal powder when the melted metal powder is solidified so that a wire is formed in the molding grooves of the molding plate.

2. The method of claim 1, wherein the molding plate includes a copper molding plate formed of a copper material.

3. The method of claim 1, wherein a thickness of the stacked metal powder is greater than a width of the molding groove by 0.1 mm.

4. The method of claim 1, wherein:
various molding plates having molding grooves with different sizes are provided; and
the molding plate corresponding to a thickness of the wire is selected and used.

5. The method of claim 1, further comprising:
rotating the wire primarily formed of the metal powder in a circumferential direction of the wire in the molding grooves of the molding plate; and
projecting a laser beam onto the rotated wire again to melt the wire so as to secondarily form the wire.

6. The method of claim 5, wherein the projecting of the laser beam onto the primarily formed wire is performed with output greater than that of the projecting of the laser beam onto the metal powder.

7. The method of claim 5, wherein a rotating angle of the wire is 180°.

8. The method of claim 1, further comprising performing a drawing process on the wire formed of the metal powder using a die so as to improve a surface roughness and a roundness of the wire.

9. The method of claim 1, further comprising rotating the wire primarily formed of the metal powder in a circumferential direction in the molding grooves of the molding plate, projecting a laser beam onto the rotated wire again to melt the wire so as to secondarily form the wire, and performing a drawing process on the secondarily formed wire using a die, which are sequentially performed to gradually improve a surface roughness, a roundness, and a hardness of the wire.

10. A molding plate for manufacturing a wire using a metal powder,
wherein a plurality of semicircular molding grooves are formed in parallel in an upper surface of a flat plate type body of the molding plate,
wherein a metal powder is stacked on the upper surface, and
wherein a laser beam is projected onto the metal powder along the molding grooves to melt the metal powder so as to form a wire.

11. The molding plate of claim 10, wherein the molding plate is formed of a copper material.

12. A molding apparatus for manufacturing a wire, the molding apparatus comprising:
a molding plate having a flat plate type body and including a plurality of semicircular molding grooves formed in parallel in an upper surface of the flat plate type body of the molding plate, wherein a metal powder is stacked on the upper surface; and
a laser beam projector configured to project a laser beam onto the metal powder stacked on the molding plate along the molding grooves to melt the metal powder so as to form a wire.

13. The molding apparatus of claim 12, further comprising:
a base having an upper surface which supports the molding plate;
a powder feeder configured to supply the metal powder to be stacked on the molding plate; and
a layering bar configured to apply the metal powder on the upper surface of the molding plate while moving along the upper surface of the base.

14. The molding apparatus of claim 13, wherein:
an installation part of the base, which supports the molding plate, is recessed downward from the upper surface of the base; and
the molding plate does not protrude from the upper surface of the base when the layering bar moves to stack the metal powder on the molding plate.

15. The molding apparatus of claim 14, further comprising a lift cylinder installed under the base to lift the installation part.

16. The molding apparatus of claim 13, further comprising:
a chamber box configured to accommodate the molding plate on the upper surface of the base, wherein an upper surface of the chamber box is formed of a transparent material through which the laser beam transmits, a lower surface of the chamber box is open to accommodate the molding plate by simply placing the chamber box on the upper surface of the base in a state in which the molding plate is mounted on the upper surface of the base; and
a gas supplier configured to supply an inert gas to the chamber box.
